(19) United States
(12) Patent Application Publication
(10) Pub. No.: US 2007/0037695 A1
(43) Pub. Date: Feb. 15, 2007

(54) Method for treating hydroprocessing catalysts with an orthophthalate and sulphuration method using the same

(76) Inventors: Claude Brun, Idron (FR); Georges Fremy, Sauveterre De Bearn (FR); Francis Humblot, Laneplaa (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/552,190

(22) PCT Filed: Mar. 26, 2004
(86) PCT No.: PCT/FR04/00768

§ 371 Date: Oct. 6, 2005

(30) Foreign Application Priority Data
Apr. 7, 2003 (FR) 03.04261

(51) Int. Cl. B01J 20/34; B01J 27/02; B01J 31/00

(52) U.S. Cl. 502/172; 502/33; 502/216

(57) ABSTRACT

Process for the impregnation of a metal hydrotreating catalyst in the oxide form with at least one orthophthalate optionally dissolved or dispersed in a liquid. Process for the sulphidation of a metal hydrotreating catalyst in oxide form, comprising: a) a stage of impregnation according to the said process, followed by b) a stage of bringing the catalyst thus treated into contact with a sulphidation agent, and by c) a stage of bringing into contact with hydrogen; stage b) being followed by stage c) or else stages b) and c) being carried out simultaneously.

The present invention relates to the field of the hydrotreating of hydrocarbonaceous feedstocks in refineries. A subject-matter of the invention is a process for the treatment of the catalysts which are able to be used for this purpose and the use of the invention in a process for the sulphidation of the said catalysts.

Hydrocarbonaceous feedstocks, such as oil fractions resulting from the atmospheric distillation or vacuum distillation unit of refineries, form the subject of a treatment with hydrogen intended in particular to reduce the content of organosulphur compounds (such as sulphides, thiophenes, benzothiophenes, dibenzothiophenes and their derivatives), of nitrogen compounds and/or of oxygen compounds. Such a treatment is known as hydrotreating and is generally carried out on oil fractions in liquid form processed at a temperature of between 300 and 400° C. and at a pressure ranging from 10 to 250 bar.

The catalysts for the hydrotreating of hydrocarbonaceous feedstocks to which the present invention relates are thus used, under appropriate conditions, for converting, in the presence of hydrogen, organosulphur compounds to hydrogen sulphide (operation known as hydrodesulphurization or HDS), organonitrogen compounds to ammonia (operation denoted by hydrodenitrogenation or HDN) and/or oxygen compounds to water and hydrocarbons (operation known under the term of hydrodeoxygenation or HDO).

These catalysts are generally based on metals from Groups VIb and VIII of the Periodic Table of the Elements, such as molybdenum, tungsten, nickel and cobalt. The most commonly used hydrotreating catalysts are formulated from cobalt-molybdenum (Co—Mo), nickel-molybdenum (Ni—Mo) and nickel-tungsten (Ni—W) systems, or from a system comprising a combination of these metals, on porous inorganic supports, such as aluminas, silicas, silicas/aluminas and zeolites.

molybdenum oxide catalysts on alumina, symbolized by the abbreviation: Co—Mo/alumina). However, they are active in hydrotreating operations only in the form of metal sulphides. This is why, before being used, they have to be subjected beforehand to an activation stage comprising a sulphidation in the presence of hydrogen.

This activation stage, also known as sulphidation, is therefore an important stage in improving the performances of hydrotreating catalysts, in particular as regards their activity and their stability over time, and a great deal of effort has been devoted to improving sulphidation procedures.

Industrial procedures for the sulphidation of catalysts are often carried out under hydrogen pressure with liquid hydrocarbonaceous feedstocks already comprising organosulphur compounds as sulphiding agents, such as those already available in the refinery. However, there are significant disadvantages to this method, related to the need to initiate the sulphidations at low temperature and to bring them slowly to high temperature in order to obtain complete sulphidation of the catalysts.

Sulphur-comprising additives have been provided for improving the sulphidation of the catalysts. The method consists in incorporating a sulphur compound (known as spiking agent) in a feedstock, such as a naphtha, or in a specific fraction, such as a VGO (vacuum gas oil) or an SRGO (straight run gas oil), which is a gas oil resulting directly from the atmospheric distillation unit.

The use is thus known, in particular from Patent EP 64 429, of DiMethyl DiSulphide (of formula CH₃—S—S—CH₃, also known as DMDS) for the sulphidation of the catalysts. With this aim, the DMDS (added to a liquid hydrocarbonaceous feedstock) and hydrogen are introduced into industrial hydrotreating reactors charged with the corresponding catalysts, this taking place after interruption of the hydrotreating reaction. Such a technique for introducing the sulphidation agent into the industrial hydrotreating reactor is described as “in situ”.

New techniques for the sulphidation of catalysts comprising two stages have more recently been developed. Patent EP 130 850 discloses such a technique. In a first stage, known as an “ex situ” stage, the catalyst is preactivated in the absence of hydrogen outside the refinery by a treatment comprising impregnation by a sulphiding agent, in the case in point an organic polysulphide. The complete sulphidation of the catalyst is carried out in the industrial hydrotreating reactor in the presence of hydrogen without further addition of sulphidation agent. The “ex situ” presulphidation relieves the refiner from injecting the sulphiding agent during the sulphidation of the catalyst in the presence of hydrogen.

As regards the DMDS, Application EP 1 046 424 teaches that the addition to the latter of an orthophthalic acid ester, for the purpose of the sulphidation of hydrotreating catalysts, makes it possible to further improve the activity of the catalysts thus activated, in particular in hydrodesulphurization. This document specifies that the introduction of the orthophthalate must for this purpose be carried out simultaneously with that of the DMDS and that such a process can be applied equally well in situ (in accordance with the example illustrated) as ex situ.

It has now been found that the sequential introduction of the orthophthalate and then of the DMDS makes possible an activation of the hydrotreating catalysts resulting in an improved activity of the latter.

A subject-matter of the present invention is thus, first, a process for the treatment of a metal hydrotreating catalyst in oxide form, characterized in that it consists in bringing it into contact, in the absence of a sulphur compound, with at least one compound chosen from orthophthalic acid, phthalic anhydride or the ester of general formula (I): 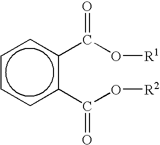
in which the symbols R¹ and R², which are identical or different, each represent an alkyl (linear or branched), cycloalkyl, aryl, alkylaryl or arylalkyl radical, it being possible for this radical to comprise from 1 to 18 carbon atoms and optionally one or more heteroatoms.

The contacting operation can be carried out by spraying the ester of formula (I) in the liquid state over a charge of the catalyst to be treated by any appropriate device, for example by a double-cone mixer or a rotary mixer. The orthophthalic acid, the phthalic anhydride and, if appropriate, the ester of formula (I) can be sprayed after they have been dissolved in a solvent with a boiling point of less than 200° C., preferably of less than 180° C.; in this case, the solvent is evaporated by heating. The ester of formula (I) can also be sprayed after it has been emulsified in water by any appropriate dispersing or emulsifying agent.

Use may be made, as solvent, of organic solvents, such as aliphatic, aromatic or alicyclic hydrocarbons, or such as alcohols, ethers or ketones.

It is preferable to bring an ester of general formula (I) into contact with the catalyst. It is preferable, in this case, to apply the ester of general formula (I) in solution in toluene.

The orthophthalic acid esters which are preferred according to the invention are those in which the symbols R¹ and R² represent identical alkyl radicals comprising from 1 to 8 carbon atoms and more particularly dimethyl orthophthalate, diethyl orthophthalate and bis(2-ethylhexyl) orthophthalate, because of their industrial accessibility and their reasonable cost.

Diethyl orthophthalate is more particularly preferred.

The amount of ester of formula (I) impregnated on the catalyst is related to the absorption capacity of the latter and is generally between 1 and 60%, preferably between 5 and 50% (expressed as weight of ester with respect to the weight of catalyst in the oxide form). Unless otherwise indicated, the percentages employed in the present text are percentages by weight.

The metal hydrotreating catalyst employed in the process according to the invention is generally a catalyst based on molybdenum, tungsten, nickel and/or cobalt oxides, which oxides are deposited on a porous inorganic support.

Preference is more particularly given to the use, as catalyst, of a mixture of oxides of cobalt and of molybdenum, a mixture of oxides of nickel and molybdenum, or a mixture of oxides of nickel and tungsten, this mixture of oxides being supported by an alumina, a silica or a silica/alumina.

Another subject-matter of the present invention is a process for the sulphidation of a metal hydrotreating catalyst in oxide form, comprising:
a) a stage of treatment of the latter as defined above, followed by
b) a stage of bringing the catalyst thus treated into contact with a sulphidation agent, and by
c) a stage of bringing into contact with hydrogen;
stage b) being followed by stage c) or else stages b) and c) being carried out simultaneously.

Use may be made, as sulphidation agent, of any sulphidation agent known to a person skilled in the art, such as a hydrocarbonaceous feedstock to be hydro-desulphurized, optionally with the addition of a sulphur compound, such as carbon disulphide, an organic sulphide, disulphide or polysulphide, a thiophene compound or a sulphur-comprising olefin.

It is preferable to employ DMDS as sulphidation agent, included in a proportion of 0.5 to 5%, preferably of 1 to 3%, in a hydrocarbonaceous feedstock.

The amount of sulphidation agent to be used is generally related to the stoichiometry of the stable forms of the metal sulphides which have to be obtained for the activation of the hydrotreating catalyst and to the amount of catalyst to be sulphided. This amount of sulphidation agent, which can be determined without excessive effort by a person skilled in the art by means of repeated tests, is generally in practice between 10% and 50% (corresponding to the ratio of the equivalent weight of sulphur of the sulphiding agent to the weight of catalyst).

According to a first preferred alternative form of the sulphidation process according to the invention, stage a) is carried out in an appropriate mixing device and the product obtained is sulphided in an industrial hydrotreating reactor, by simultaneous implementation of stages b) and c). Use may be made, for stage a), of any appropriate device, for example a double-cone mixer or a rotary mixer. In this case, the sulphidation is carried out according to a technique of “in situ” type.

According to a second alternative form of the process according to the invention, stage a) and the operation in which the catalyst obtained is brought into contact with the sulphidation agent (in accordance with stage b)) are carried out in two appropriate mixing devices which are identical or different, such as a mixer of the above type. Stage c) is then carried out in an industrial hydrotreating reactor. In this case, the sulphidation is carried out according to a technique of “ex situ” type.

According to another alternative form of the process according to the invention, stage a) is carried out in an industrial hydrotreating reactor and is followed by the sulphidation of the catalyst thus treated in the same reactor by simultaneous implementation of stages b) and c). In this case, the sulphidation is carried out according to a technique of “in situ” type.

The other conditions for carrying out the sulphidation of the catalyst, such as those relating to the temperatures to be adopted, to the time necessary or to the flow rate of the sulphidation agent or the hydrogen pressure, are those normally known to a person skilled in the art.

The examples which follow are given purely by way of illustration of the invention and should not be used to limit the scope thereof.

### EXAMPLE 1

### (Comparative) Sulphidation of the Catalyst with DMDS

1.1. Implementation of the Sulphidation:

Use is made of a cylindrical reactor made of stainless steel (internal volume of 120 ml) placed in an oven and of a commercial hydrodesulphurization catalyst supported on alumina and comprising 3.3% of cobalt and 8.6% of molybdenum (in the form of oxides).

40 ml (31 g) of the catalyst are placed in the reactor between two layers of silicon carbide (SiC), an inert agent which promotes the homogeneous distribution of the gas and liquid streams and which also acts as thermal buffer.

After drying under a nitrogen flow at 150° C., the catalyst is wetted (at this same temperature) with a gas oil resulting from the atmospheric distillation of a crude oil (straight run gas oil, hereinafter referred to as SRGO) and exhibiting the characteristics collated in the following table:

TABLE 1

| Type of feedstock | | SRGO |
|---|---|---|
| Density, 15° C. | g/cm³ | 0.8741 |
| Nitrogen | ppm | 239 |
| Sulphur | % wgt | 1.1 |
| ASTM D86 | | |
| S.P. | ° C. | 227.3 |
| 5% vol. | ° C. | 274.5 |
| 10% vol. | ° C. | 292.0 |
| 30% vol. | ° C. | 315.5 |
| 50% vol. | ° C. | 332.0 |
| 70% vol. | ° C. | 348.0 |
| 90% vol. | ° C. | 367.0 |
| 95% vol. | ° C. | 373.0 |
| F.p. | ° C. | 373.7 |

After having placed the reactor under hydrogen pressure, the DMDS is injected with a flow rate of 1.05 g/h into the SRGO. The sulphidation with DMDS is carried out under the following conditions:
30 bar of hydrogen pressure
ratio: flow of hydrogen (expressed in litres, measured under standard temperature and pressure conditions)/flow of SRGO (expressed in litres) equal to 250 SI/I
hourly space velocity (ratio of the flow rate by volume of the SRGO to the volume of the catalyst) HSV=2 h⁻¹
rise in temperature from 150° C. to 220° C. at the rate of 30° C./hour
stationary temperature phase at 220° C., maintained until 0.3% by volume of H₂S is obtained in the outlet gases from the reactor;
rise in temperature to 320° C. at the rate of 30° C./h;
stationary phase at 320° C. for 14 hours.

At the outlet of the reactor, after passing through a gas/liquid separator, the liquid phase is recycled upstream of the catalytic reactor.

The total sulphidation time is 24 hours.

The catalyst is recovered, washed and dried under a nitrogen flow.

1.2. Test of the Activity of the Catalyst in the Hydrodesulphurization Reaction of Thiophene:

The activity of the catalyst activated (or sulphided) in accordance with point 1.1. above is tested in the hydrosulphurization reaction of thiophene.

This reaction, carried out in the presence of hydrogen, has the effect of converting the thiophene to hydrocarbonaceous products, such as butadiene, butane or butene, with simultaneous formation of H₂S. The activity of the catalyst in this reaction is representative of its activity in the hydrodesulphurization of hydrocarbonaceous feedstocks.

A portion of the catalyst activated in accordance with 1.1. is milled under argon to produce particles with a size of 0.2 to 0.5 mm which are mixed with silicon carbide (SiC).

15 mg of this mixture are placed in a tubular glass reactor with a capacity of 10 ml.

This reactor, brought to a temperature of 400° C., is fed with:
a hydrogen flow rate of 5.4 SI/hour, and
thiophene at a partial pressure of 8 kPa, corresponding to a flow rate by mass of 1.5 g/h,

for a total pressure of 101 kPa.

The activity of the catalyst is determined by the rate constant k of the reaction per gram of catalyst and is expressed in terms of relative weight activity (RWA), with the aim of making it possible to compare the activities resulting from various activation (or sulphidation) treatments. This RWA is calculated in the following way.

After each activation treatment with DMDS (preceded or not preceded by a 1st stage comprising impregnation by an orthophthalate), the rate constant (k) is calculated from the measurement by chromatographic analyses of the residual thiophene content in the gases emerging from the outlet of the reactor. The RWA is the ratio of this activity constant to that of the present reference test (catalyst sulphided with DMDS), expressed as percentage, i.e. 100×k/k_{ref}.

Thus, the RWA of the catalyst sulphided with DMDS in accordance with Example 1 is 100%.

1.3. Test of the Activity of the Catalyst in the Hydrodesulphurization Reaction of an Oil Fraction:

This activity test consists in measuring the residual sulphur content of the oil fraction after the catalytic hydrotreating reaction. This type of test is very similar to the industrial conditions of the use of hydrotreating catalysts.

In these tests, the oil fraction is a gas oil, the main characteristics of which are given in Table 2.

TABLE 2
Main physicochemical properties of the gas oil used to
determine the activity of the hydrotreating catalysts

| Type of feedstock | | SRGO |
|---|---|---|
| Density, 15° C. | g/cm³ | 0.8517 |
| Nitrogen | ppm | 114 |
| Sulphur | % wgt | 1.32 |
| ASTM D86 | | |
| S.P. | ° C. | 207.3 |
| 5% vol. | ° C. | 247.8 |
| 10% vol. | ° C. | 259.9 |
| 30% vol. | ° C. | 283.4 |
| 50% vol. | ° C. | 301.2 |
| 70% vol. | ° C. | 320.3 |
| 90% vol. | ° C. | 347.5 |
| 95% vol. | ° C. | 357.7 |
| F.p. | ° C. | 363.9 |

3 ml of the catalyst activated in accordance with paragraph 1.1 of the present example are milled, so as to obtain a powder with a particle size of between 200 and 500 μm. This catalyst is mixed with the same volume of a silicon carbide powder and then placed in the central part of a tubular reactor (internal diameter 10 mm, height 190 mm). The inlet and the outlet of the reactor are filled with a layer of silicon carbide which acts as thermal buffer and which provides the catalytic bed with good mechanical stability.

The hydrogen and the gas oil are then introduced at ambient temperature in an ascending stream.

The reactor is subsequently brought to 350° C. at the rate of a temperature rise of 60° C./hour. After a period of stabilization of 15 hours, regular samples of liquid are withdrawn from the outlet of the reactor over 8 hours and are then degassed with nitrogen to remove any traces of dissolved hydrogen sulphide. The test conditions are summarized in Table 3.

TABLE 3
Operating conditions of the activity test

| Temperature | 350° | C. |
|---|---|---|
| Hydrogen pressure | 40 | bar |
| Direction of flow | ascending | |
| Gas oil flow rate | 6 | ml/h |
| Catalyst volume | 3 | ml |
| Hydrogen flow rate | 2 | Sl/h |

The residual concentration of sulphur in the liquid emerging from the outlet of the reactor is measured for each sample and, after calculating the mean sulphur concentration, the rate constant (k) which characterizes the activity of one millilitre of the catalyst is determined by the following formula:

$$k = \frac{LHSV}{n - 1} \times ( \frac{1}{{C}_{gas oil outlet}^{n - 1}} - \frac{1}{{C}_{feedstock}^{n - 1}} )$$

in which
LHSV represents the liquid hourly space velocity expressed in h⁻¹, LHSV being defined by:

$$LHSV = \frac{gas oil flow rate ( ml \text{/} h )}{catalyst volume ( ml )}$$

n: order of the reaction being equal to 1.65 in the case of the hydrodesulphurization of gas oil,

C gas oil outlet: concentration of sulphur present in the sample (ppm),

C feedstock: concentration of sulphur present in the gas oil feedstock used (i.e. 13 200 ppm).

For the purpose of making it possible to compare the activities resulting from different activation treatments, in particular with respect to a reference treatment, the activity of the catalyst (characterized by the rate constant (k)) is expressed in terms of relative volumic activity (RVA) by the following formula:

$$RVA = \frac{{k}_{sample}}{{k}_{standard}} \times 100$$

in which:

k sample is the rate constant of the catalyst tested

k standard is the rate constant of the reference catalyst (catalyst sulphided with DMDS in accordance with Example 1)

Thus, the RVA of the catalyst sulphided with DMDS in accordance with Example 1 is 100%.

### EXAMPLE 2

### Impregnation of the Catalyst Used in Example 1 with 9.2% of DiEthyl Phthalate (or DEP)

Use is made of the same hydrotreating catalyst as in Example 1 and of a jacketed tubular glass reactor with a volume of 200 ml equipped with a sintered glass welded to its bottom part.

40 ml (corresponding to 31 g) of the catalyst are deposited on the sintered glass of the reactor, into which a solution of 2.86 g of DEP in 32.5 g of toluene is subsequently introduced. The ratio of DEP to total weight of the catalyst in the form of the corresponding oxide is 9.2% by weight. The DEP and the catalytic charge are kept in contact at ambient temperature for 30 minutes.

The temperature of the reactor is subsequently brought to 100° C. and nitrogen is passed through the reactor to evaporate the toluene.

### EXAMPLE 3

### Sulphidation with DMDS of the Catalyst Treated in Accordance with Example 2

The sulphidation treatment with DMDS of point 1.1. of Example 1 is repeated with regard to the catalyst obtained in Example 2.

The activity of the catalyst thus sulphided is measured by the test of hydrodesulphurization of thiophene described in point 1.2. of Example 1.

An RWA of 116 is obtained.

The preliminary impregnation with DEP consequently makes it possible to significantly increase the activity of a catalyst sulphided with DMDS.

### EXAMPLE 4

### Impregnation of the Catalyst Used in Example 1 with 19.6% of DEP

Example 2 is repeated so as to obtain a ratio of DEP to total weight of catalyst (in oxide form) of 19.6%.

### EXAMPLE 5

### Sulphidation with DMDS of the Catalyst Treated in Accordance with Example 4

Example 3 is repeated using, as catalyst, that prepared in accordance with Example 4.

An RWA in the desulphurization of thiophene of 112 is measured.

### EXAMPLE 6

### Impregnation of a Hydrotreating Catalyst with 28.3% of DEP

230 ml (180 g) of a commercial hydrodesulphurization catalyst, composed of 3.3% of cobalt and 12.1% of molybdenum (in the form of oxides) supported on alumina, are placed in a 500 ml round-bottomed glass flask and then a solution composed of 46 ml (51 g) of DEP and of 51 ml (44 g) of toluene is run onto this catalyst. The combined mixture is left at ambient temperature for 12 hours and then the toluene is evaporated under vacuum at 60° C. using a rotary evaporator.

The amount of DEP thus introduced onto the catalyst corresponds to 28.3% of the weight of commercial hydrodesulphurization catalyst (in the oxide form).

### EXAMPLE 7

### Sulphidation with DMDS of the Catalyst Treated in Accordance with Example 6

The sulphidation treatment with DMDS of point 1.1. of Example 1 is repeated on the catalyst obtained in Example 6, without, however, recycling the liquid phase upstream of the reactor.

The activity of the catalyst thus sulphided is measured by the hydrodesulphurization test on an oil fraction described in point 1.3. of Example 1, in which the reference rate constant k standard is that measured for the commercial catalyst used for Example 6 and sulphided with DMDS.

An RVA of 116 is obtained.

The fact that the preliminary impregnation with DEP makes it possible to significantly increase the activity of a catalyst sulphided with DMDS is thus corroborated.

### EXAMPLE 8

### Impregnation of the Catalyst used in Example 6 with 40.5% of DEP

53 ml (41 g) of the catalyst used in Example 6 are placed in a 250 ml round-bottomed glass flask. A solution composed of 14.8 ml (16.6 g) of DEP and of 8.4 ml (7.2 g) of toluene is subsequently run onto this catalyst. The combined mixture is left at ambient temperature for 12 hours and then the toluene is evaporated under vacuum at 60° C. using a rotary evaporator.

The amount of DEP thus introduced onto the catalyst corresponds to 40.5% of the weight of commercial hydrodesulphurization catalyst (in the oxide form).

### EXAMPLE 9

### Sulphidation with DMDS of the Catalyst Treated in Accordance with Example 8

The sulphidation treatment with DMDS of Example 1 is repeated using the catalyst treated in accordance with Example 8 but without, however, recycling the liquid phase upstream of the reactor.

The test of activity in the hydrodesulphurization of gas oil (described in point 1.3. of Example 1) results in an RVA measurement of 137.

1. Process for the treatment of a metal hydrotreating catalyst in oxide form, characterized in that it consists in bringing it into contact, in the absence of a sulphur compound, with at least one compound chosen from orthophthalic acid, phthalic anhydride or the ester of general formula (I): 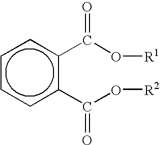
in which the symbols R¹ and R², which are identical or different, each represent an alkyl (linear or branched), cycloalkyl, aryl, alkylaryl or arylalkyl radical, it being possible for this radical to comprise from 1 to 18 carbon atoms and optionally one or more heteroatoms.

2. Process according to claim 1, characterized in that the compound brought into contact with the catalyst is an ester of general formula (I).

3. Process according to either of claims 1 and 2, characterized in that the ester of formula (I) is such that the symbols R¹ and R² represent identical alkyl radicals comprising from 1 to 8 carbon atoms.

4. Process according to one of claims 1 to 3, characterized in that the ester of formula (I) is diethyl orthophthalate.

5. Process according to one of claims 1 to 4, characterized in that the hydrotreating catalyst is based on molybdenum, tungsten, nickel and/or cobalt oxides, which oxides are deposited on a porous inorganic support.

6. Process according to one of claims 1 to 5, characterized in that the ester of formula (I) brought into contact with the catalyst is dissolved in toluene.

7. Process for the sulphidation of a metal hydrotreating catalyst in oxide form, comprising:
a) a stage of treatment as defined in one of claims 1 to 6, followed by
b) a stage of bringing the catalyst thus treated into contact with a sulphidation agent, and by
c) a stage of bringing into contact with hydrogen;
stage b) being followed by stage c) or else stages b) and c) being carried out simultaneously.

8. Process according to claim 7, characterized in that the sulphidation agent is a hydrocarbonaceous feedstock to be hydrodesulphurized, optionally with the addition of a sulphur compound, such as carbon disulphide, an organic sulphide, disulphide or polysulphide, a thiophene compound or a sulphur-comprising olefin.

9. Process according to either of claims 7 and 8, characterized in that DMDS is employed as sulphidation agent, included in a proportion of 0.5 to 5%, preferably of 1 to 3%, in a hydrocarbonaceous feedstock.

10. Process according to one of claims 7 to 9, characterized in that stage a) is carried out in an appropriate mixing device and the product obtained is sulphided in an industrial hydrotreating reactor, by simultaneous implementation of stages b) and c).

11. Process according to one of claims 7 to 9, characterized in that stage a) and the operation in which the catalyst obtained is brought into contact with the sulphidation agent in accordance with stage b) are carried out in two mixing devices which are identical or different and stage c) is carried out in an industrial hydrotreating reactor.

12. Process according to one of claims 7 to 9, characterized in that stage a) is carried out in an industrial hydrotreating reactor and is followed by the sulphidation of the catalyst thus treated in the same reactor by simultaneous implementation of stages b) and c).
